(19) United States
(12) Patent Application Publication
(10) Pub. No.: US 2013/0160231 A1
(43) Pub. Date: Jun. 27, 2013

(54) FLOOR CARE APPLIANCE WITH INTERCHANGEABLE DIRT COLLECTION MODULES

(71) Applicants: Eric J. Streciwilk, Danville, KY (US); Brian K. Ruben, Danville, KY (US); Gerald Michael Harrison, Lancaster, KY (US)

(72) Inventors: Eric J. Streciwilk, Danville, KY (US); Brian K. Ruben, Danville, KY (US); Gerald Michael Harrison, Lancaster, KY (US)

(21) Appl. No.: 13/337,790

(22) Filed: Dec. 27, 2011

(51) Int. Cl. A47L 9/10; B23P 17/00

(52) U.S. Cl. 15/347; 29/469

(57) ABSTRACT

An upright vacuum cleaner includes a base unit having a suction inlet, a suction generator and a locating element. The vacuum cleaner also includes first and second dirt collection modules. The first dirt collection module has a receiver that cooperates and engages with the locating element so that it may be properly secured to the base unit. An adapter allows the second dirt collection module to be properly secured to the base unit instead of the first dirt collection module.

### TECHNICAL FIELD

This document relates generally to the floor care equipment field and, more particularly, to a floor care appliance or upright vacuum cleaner with interchangeable dirt collection modules.

### BACKGROUND

Upright vacuum cleaners are well known in the floor care equipment field. Upright vacuum cleaners generally include a nozzle assembly equipped with wheels so as to roll freely along the floor. The nozzle assembly generally includes a suction inlet and, more often than not, a rotary agitator for sweeping dirt and debris from the nap of an underlying carpet being cleaned. A handle assembly is pivotally attached to the nozzle assembly. The handle assembly may be moved from an upright, rest or storage position to an oblique operating position where the handle pivots with respect to the nozzle assembly as the operator guides the vacuum cleaner to and fro across the floor.

Upright vacuum cleaners also include a suction generator for producing a negative air stream that draws air entrained with dirt and debris into the vacuum cleaner. That air stream is drawn into a dirt collection vessel where dirt and debris is collected from the air stream and the relatively clean air is then exhausted from the vacuum cleaner.

Generally, the dirt collection vessel may take two forms. In the first form, the vacuum cleaner housing includes a bag compartment which receives and holds a disposable bag made of a filter material. More specifically, the air stream entrained with dirt and debris is directed into the interior of the bag. The filter material of the bag allows the passage of clean air while at the same time preventing the passage of dirt and debris thereby trapping the dirt and debris and removing it from the air stream. In the second form, the dirt collection vessel is a dirt cup which may or may not incorporate structures providing for cyclonic air flow.

Some consumers favor a vacuum cleaner equipped with a disposable filter bag while other consumers favor a vacuum cleaner equipped with a reusable dirt cup. As a consequence, many vacuum cleaner manufacturers produce both types or forms of upright vacuum cleaners. In the past this has typically required construction of two independent nozzle assemblies or base units with one of the assemblies specifically adapted for use with a dirt collection vessel in the form of a filter bag while the other is specifically adapted for use with a dirt collectiori vessel in the form of a dirt cup. The need for the construction and manufacturing of two separate nozzle assemblies or base units requires additional design time, mold construction, additional part inventories and often two separate assembly lines. These and other considerations all add significantly and unnecessarily to manufacturing costs.

The present invention relates to an upright vacuum cleaner incorporating a single base unit which may be connected to a first dirt collection module incorporating a dirt cup or a second dirt collection module incorporating a bag compartment and filter bag. Thus, only one base unit needs to be designed and manufactured and only one base unit parts inventory needs to be maintained. As a consequence, manufacturing costs are significantly reduced for the manufacturer.

### SUMMARY

An upright vacuum cleaner is provided comprising (a) a base unit including a suction inlet, a suction generator and a locating element, (b) a first dirt collection module, (c) a second dirt collection module and (d) an adapter. The first dirt collection module has a receiver that cooperates and engages with the locating element on the base unit whereby the first dirt collection module may be secured to the base unit in a proper operating position. The adapter may be positioned between the locating element on the base unit and the second dirt collection module so as to allow the second dirt collection module to be properly secured to the base unit instead of the first dirt collection module. In this way a single base unit design may be used in the manufacture of an upright vacuum cleaner incorporating either a reusable dirt cup or a disposable filter bag.

More specifically, the base unit further includes a suction conduit and a dirt collection module mounting boss. The. first and second dirt collection modules both include (a) a connection conduit that engages the suction conduit and (b) a mounting element that engages the mounting boss. In addition, a fastener is provided. The fastener is received in the mounting boss and the mounting element of either the first and second dirt collection modules when the module is properly seated on the base unit.

In one particularly useful embodiment the suction conduit and the mounting boss are adjacent to one another. Further, the connection conduit has a first end that friction fits inside an open or second end of the suction conduit. In addition, the mounting boss nests inside the mounting element of either the first or second dirt collection module.

The adapter includes a retaining rib that is received in an undercut in the locating element or projecting lug to provide a secure connection. Further, the adapter includes first and second projections or convexities. The First projection is received in a first cavity provided in the housing of the second dirt collection module that defines the bag compartment. The second projection is received in a second cavity provided in an access door of the housing that provides access to the bag compartment for checking and changing a filter bag.

In accordance with additional aspects, a method is provided for reducing vacuum cleaner manufacturing costs. The method may be broadly defined as including the steps of: (a) producing at least two base units of a single embodiment or design including a suction inlet; (b) producing a first dirt collection module having a dirt cup; (c) producing a second dirt collection module having a bag compartment and a filter bag; (d) attaching the first dirt collection module to one of the at least two base units to make an upright vacuum cleaner with a dirt cup; and (e) attaching the second dirt collection module to another of the at least two base units to make an upright vacuum cleaner with a filter bag. By utilizing a single embodiment of base unit to make two different types of vacuum cleaners parts and manufacturing costs are both reduced.

In the following description there is shown and described preferred embodiments of the vacuum cleaner. As it will be realized, the vacuum cleaner is capable of other different embodiments and their several details are capable of modification in various, obvious aspects. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the vacuum cleaner and together with the description serve to explain certain principles of its construction and operation. In the drawings:

FIG. 1 is a front elevational view of a first embodiment of a vacuum cleaner;

FIG. 2 is a left side elevational view of the embodiment illustrated in FIG. 1;

FIG. 3 is a rear elevational view of the embodiment illustrated in FIG. 1;

FIG. 3a is a bottom plan view of the embodiment illustrated in FIG. 1;

FIG. 4 is an exploded perspective view of the embodiment illustrated in FIG. 1;

FIG. 5 is a detailed cross sectional view showing the mounting of the handle and the conduit connection of the embodiment illustrated in FIG. 1;

FIG. 6 is a detailed cross sectional view showing the locating element received in the receiver/cavity at the bottom of the dirt cup of the embodiment illustrated in FIG. 1;

FIG. 7 is a left side elevational view of a second embodiment of a vacuum cleaner incorporating a bag compartment and filter bag;

FIG. 8 is an exploded perspective view of the second embodiment illustrated in FIG. 7;

FIGS. 9a and 9b are respective detailed perspective and top plan views of the adapter utilized to connect the second dirt collection module to the base unit of the embodiment illustrated in FIG. 7;

FIGS. 10 and 11 are respective transverse and axial cross sectional views illustrating the connection of the adapter to the locating element and the connection of the bag compartment housing to the adapter; and

FIG. 12 is a detailed cross sectional view showing the mounting of the housing to the mounting boss of the base unit.

Reference will now be made in detail to the present preferred embodiments of the vacuum cleaner, examples of which are illustrated in the accompanying drawings.

### DETAILED DESCRIPTION

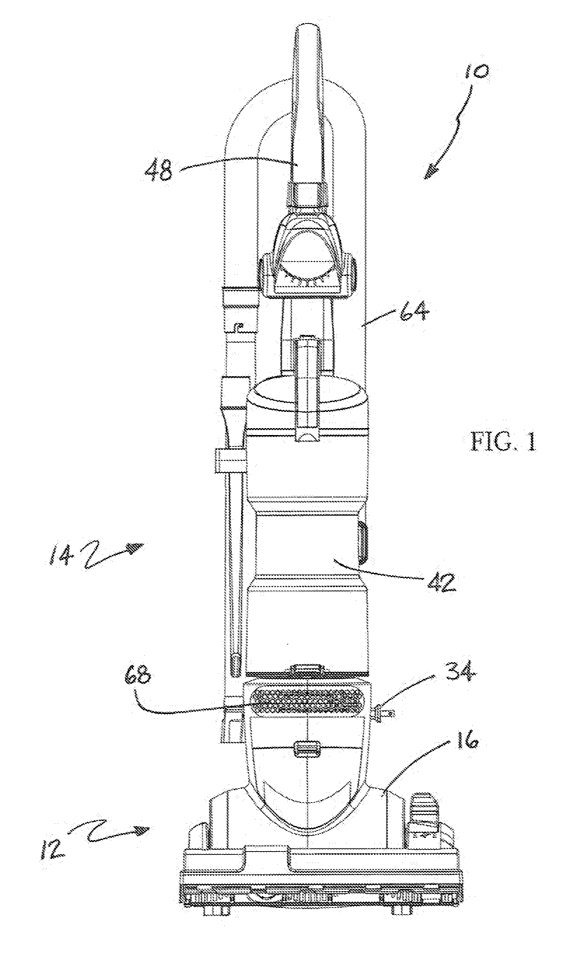

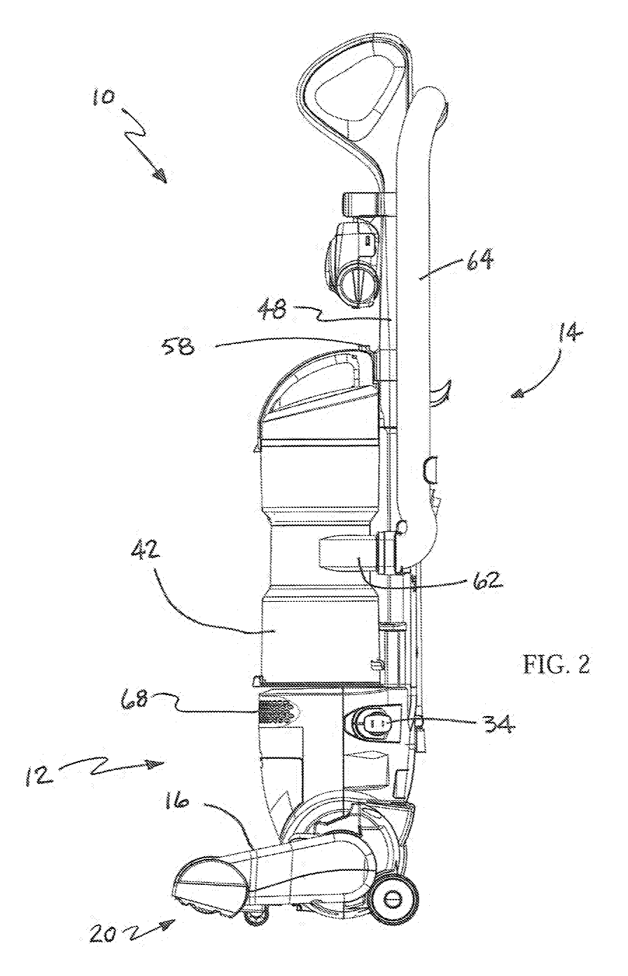

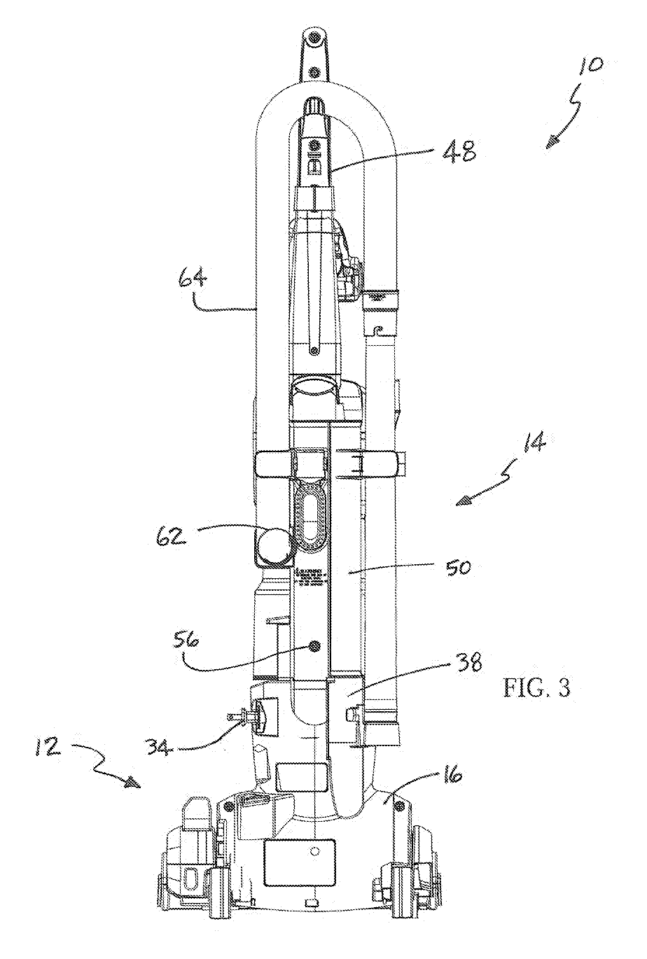

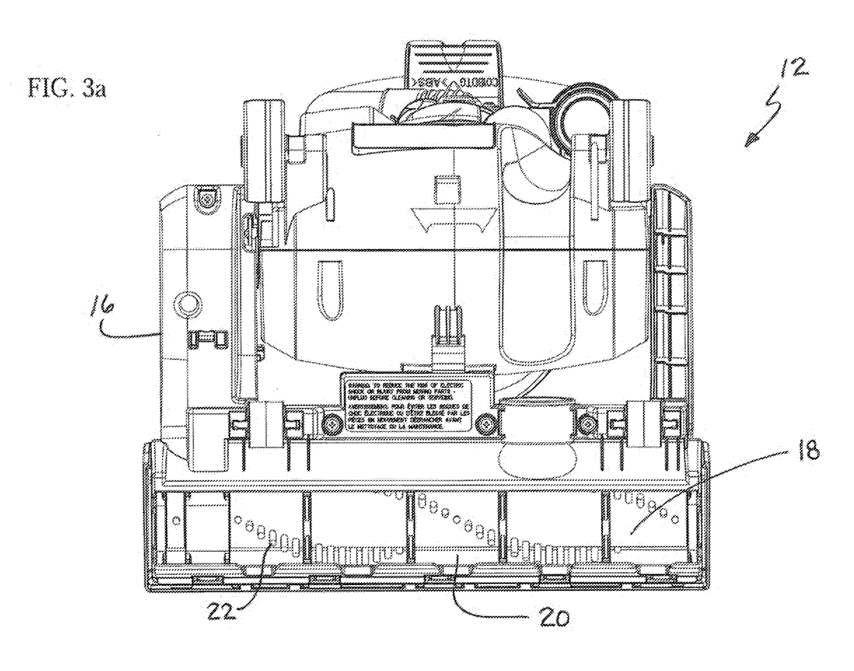

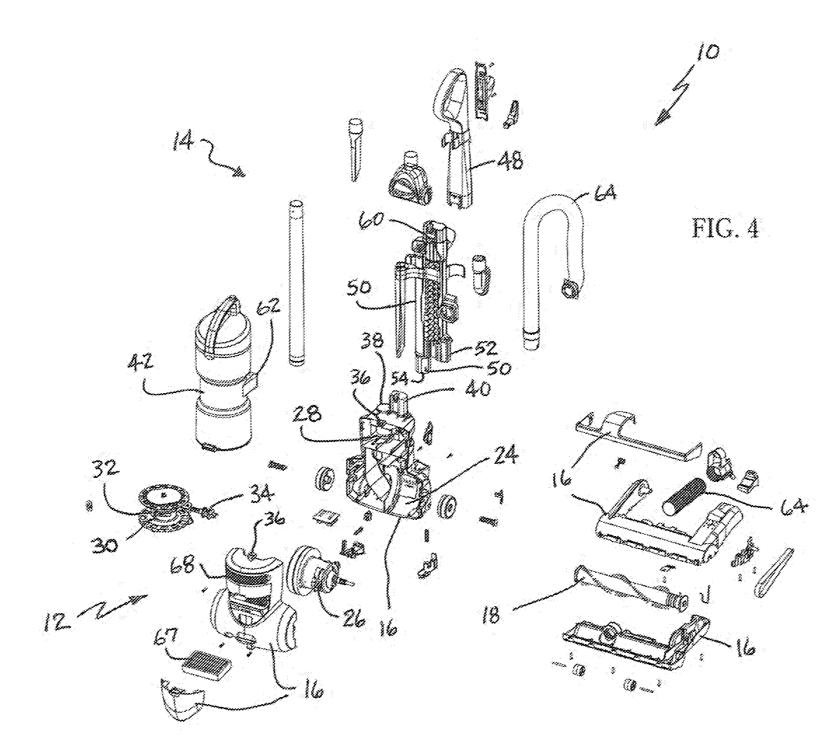

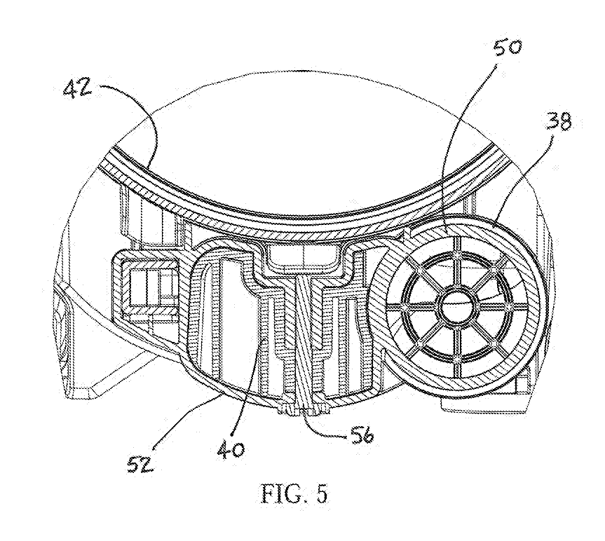

Reference is now made to FIGS. 1-6 illustrating a first embodiment of an upright vacuum cleaner 10 including a base unit 12 and a first dirt collection module 14. The base unit 12 includes an outer housing 16 and carries a rotary agitator 18 in a suction inlet 20. The rotary agitator 18 may include a series of cleaning projections such as bristle tufts 22 which function to beat and sweep dirt and debris from the nap of an underlying carpet being cleaned (see particularly FIG. 3a). As best illustrated in FIG. 4, the housing 16 includes a suction generator compartment 24 for receiving and holding a suction generator 26 and a cord reel compartment 28 for receiving a cord reel assembly 30 of a type known in the art for paying out and taking up an electrical power cord 32. An electrical plug 34 at the end of the electrical power cord 32 is connected to a standard electrical wall outlet in order to provide power for operating the vacuum cleaner 10.

A locating element 36 in the form of a projecting lug is provided on the top of the housing 16. As best illustrated in FIG. 4, the base unit 12 also includes a suction conduit 38 and a dirt collection module mounting boss 40.

The first dirt collection module 14 includes a dirt cup 42. The dirt cup 42 may be a simple dirt cup with an inlet and an outlet. Alternatively, the dirt cup 42 may include a cylindrical side wall, a tangentially directed inlet and an axially directed outlet in order to provide cyclonic airflow characteristics for enhanced cleaning action. Further, the dirt cup may or may not include a primary filter covering the outlet.

As further illustrated in FIGS. 3, 4 and 6 a receiver 44 is provided in the bottom wall 46 of the dirt cup 42. In the illustrated embodiment, the receiver 44 takes the form of a cavity. The first dirt collection module 14 also includes a handle or control stalk 48 which may be manipulated by an operator to control the movement and direction of the vacuum cleaner 10. Further the first dirt collection module 14 includes a connection conduit 50 and a mounting element 52 adapted to engage the mounting boss 40 on the base unit 12. More specifically, the first dirt collection module 14 is positioned over the base unit 12 with the connection conduit 50 aligned with the suction conduit 38 and the mounting element 52 aligned with the mounting boss 40. The first dirt collection module 14 and base unit 12 are then brought together so that the first end 54 of the connection conduit 50 is received in the open end of the suction conduit 38 while the mounting boss 40 simultaneously nests inside the mounting element 52. More specifically, the connection conduit 50 provides a good friction fit with the suction conduit 38 and the mounting boss 40 simultaneously provides a good friction fit with the mounting element 52. A fastener, such as a screw or bolt 56, is tightened to provide threaded engagement with the mounting boss 40 and mounting element 52. The dual friction fit provided by the adjacent interconnected conduits 38, 50 and mounting boss/element 40, 52 in combination with the fastener 56 provide a positive, secure and stable connection between the base unit 12 and the first dirt collection module 14.

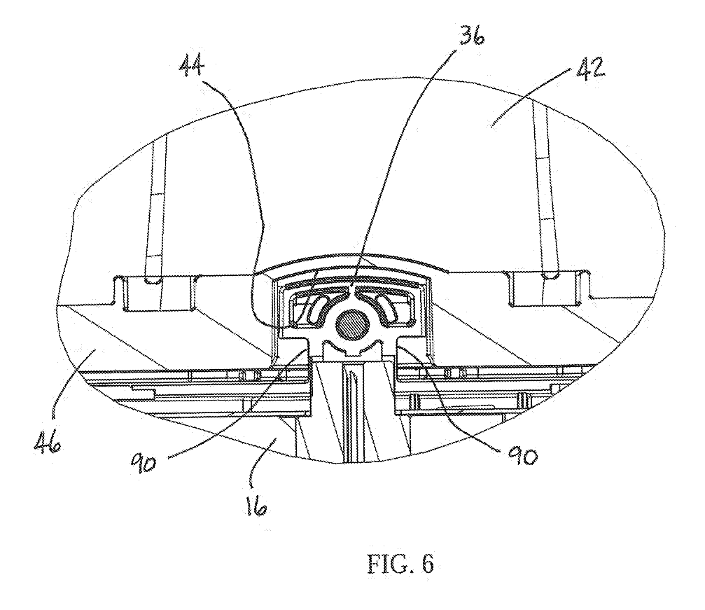

When properly mounted to the first dirt collection module 14, the receiver or cavity 44 in the bottom wall 46 of the dirt cup 42 is received on the locating element 36 (see FIG. 6). Simultaneously, a releasable latch 58 carried on the handle 60 of the dirt cup 42 engages a latch receiver 60 carried by the control stalk 48. This secures the dirt cup 42 in the desired operating position. When properly seated, the inlet 62 of the dirt cup 42 is aligned with the conduit 64 in communication with the suction inlet 20 while the outlet (not shown) of the dirt cup is in communication with the connection conduit 50 held in the suction conduit 38 in fluid communication with the suction generator 26.

During operation of the vacuum cleaner 10 illustrated in FIGS. 1-6, the rotary agitator 18 beats and sweeps dirt and debris from the nap of an underlying carpet toward the suction inlet 20. Simultaneously, the suction generator 26 draws an air stream entrained with this dirt and debris through the suction inlet 20 and the conduit 64 toward the dirt cup 42. That dirt entrained air stream then passes through the inlet 62 into the dirt cup 42. Dirt and debris are trapped in the dirt cup 42 while the now clean air is drawn through the connection conduit 50 and suction conduit 38 to the suction generator compartment 24. There the air stream passes over the motor of the suction generator 26 to provide cooling. The air stream is then routed from the suction generator compartment 24 through the cord reel compartment 28 where the air stream provides cooling for the cord reel assembly 30 including the contacts (not shown). The air stream is then directed through afinal filter, such as a HEPA filter 67, before being exhausted into the environment through the exhaust vent 68 in the front of the vacuum cleaner.

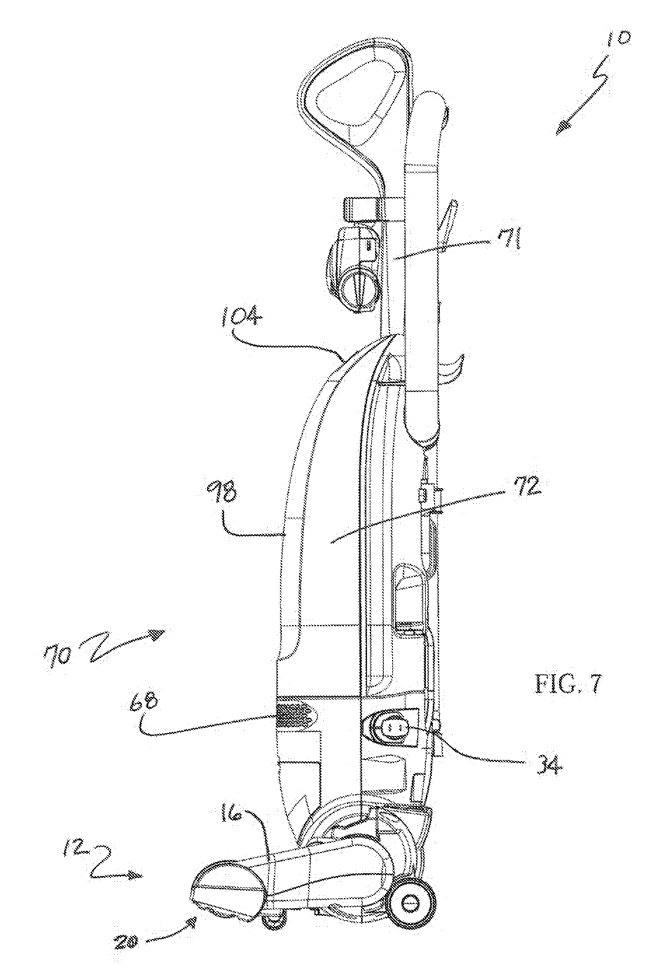

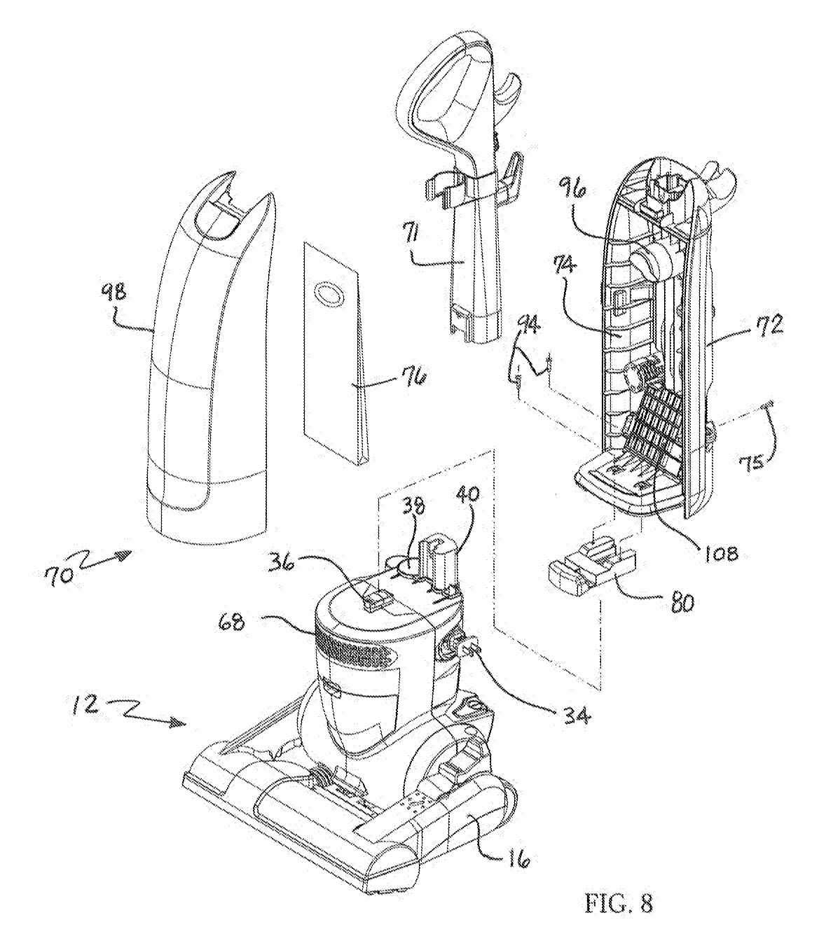

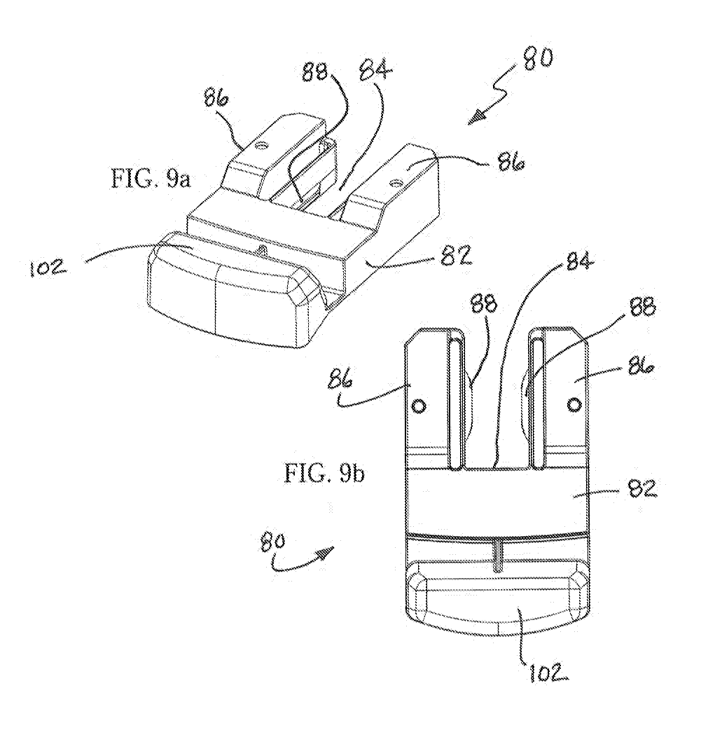

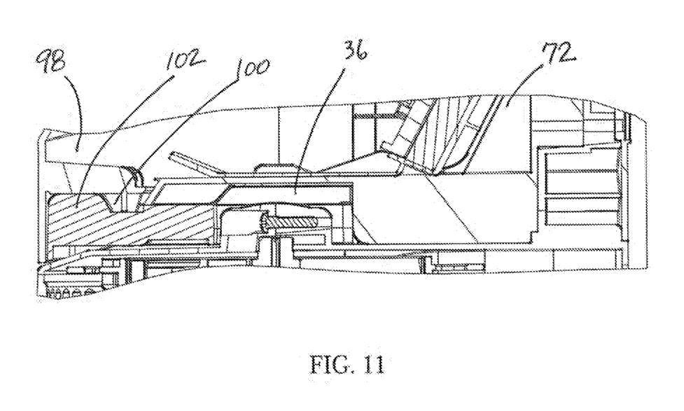

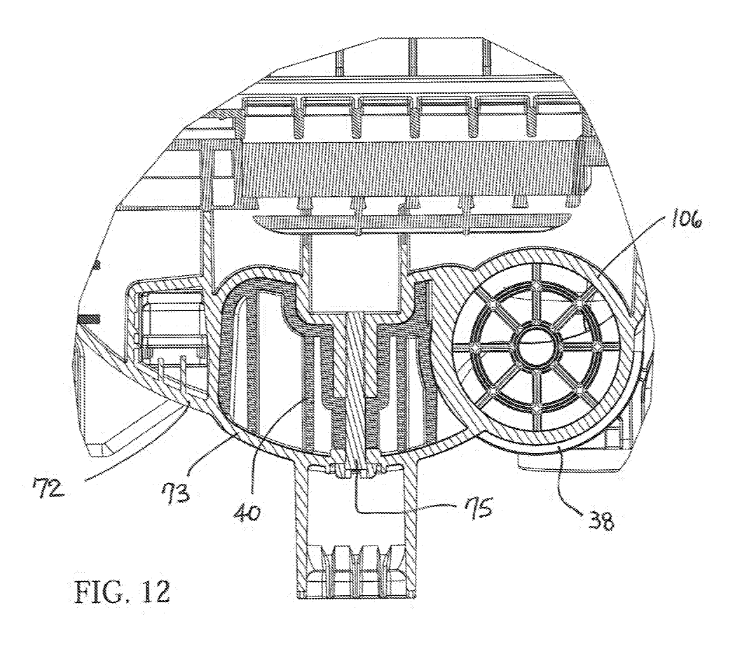

As should be appreciated from viewing FIGS. 7-12, the base unit 12 which connects to the first dirt collection module 14 also connects to a second dirt collection module 70. The second dirt collection module 70 includes a control stalk 71 having a mounting element 72 that engages in friction fit over the mounting boss 40 of the base unit 12. A fastener 75 such as a screw of bolt, is received in aligned, cooperating threaded apertures provided in the mounting element 72 and mounting boss 40 to provide a secure connection. The second dirt collection module 70 also includes a housing 72 that forms a bag compartment 74 for receiving a disposable filter bag 76. The connection between the base unit 12 and the second dirt collection module 70 is possible by means of the use of an adapter 80. As best illustrated in FIGS. 9a and 9b, the adapter 80 includes a body 82 having an open ended slot 84 defined between a pair of first projections or convexities 86. A pair of opposed retaining ribs 88 project from the body 82 into the open slot 84.

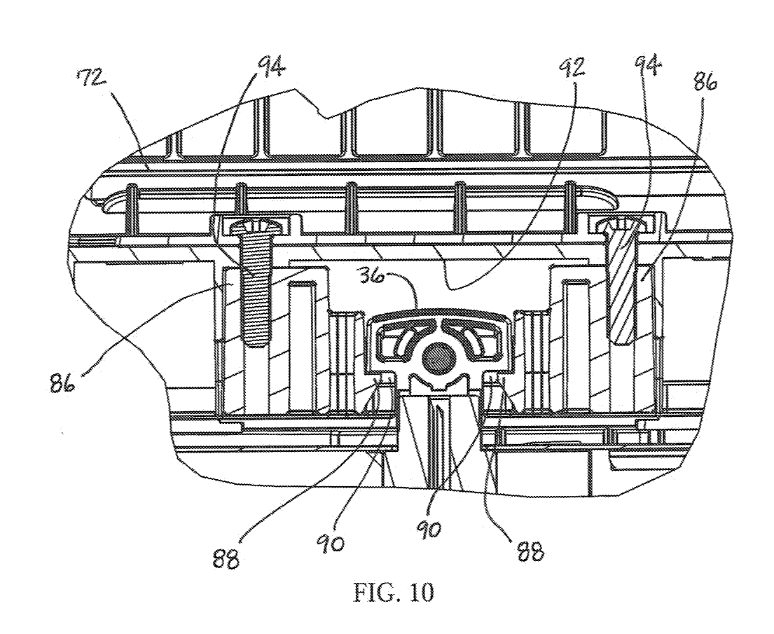

When the adapter 80 is properly seated on the locating element 36 of the base unit 12, the retaining ribs 88 are received and held in cooperating undercuts 90 provided in the locating element 36 (see particularly FIG. 10). The adapter 80 may be positioned on the locating element 36 with the retaining ribs 88 in the undercuts 90 by sliding the adapter over the locating element through the open end of the slot 84. The housing 72 may then be seated on the adapter 80 and base unit 12 with the first projections 86 received in the cooperating first cavity 92 provided in the bottom wall of the housing. Cooperating fasteners such as screws or bolts 94 may be tightened is aligned threaded openings in the bottom wall of a housing 72 and the adapter 80 to complete the connection. A filter bag 76 may then be positioned in the housing 72 with the opening of the filter bag provided over the suction tube 96. The housing access door 98 may then be secured in position to close the bag compartment 74. More specifically, a second cavity 100 in the bottom wall of the access door 98 is aligned with and receives the second projection 102 or convexity on the adapter 80. A cooperating latch 104 at the top of the housing 72 completes the connection of the access door 98 to seal the bag compartment 74.

The adapter 80 may also be made of a resilient material that provides a snap fit over the locating element 36. In this situation, the adapter 80 may be secured to the bottom wall of the housing 72 with the first projections 86 received in the first cavity 92 by means of the fasteners 94. The housing 72 may then be snapped into position on the base unit 12 by aligning the adapter 80 over the locating element 36 and pressing downwardly. Under these circumstances, the adapter 90 flexes slightly to open the slot 84 and allow the retaining ribs 88 to pass over the locating element 36 until they reach the undercuts 90. At that time the resiliency of the adapter 80 causes the body 82 to return to its rest position and the slot 84 closes so that the retaining ribs 88 are received fully in the undercuts 90 to firmly and positively secure the housing 72 in position.

As should be appreciated, the housing 72 of the second dirt collection module 70 also includes a connection conduit 106. As the housing 72 is seated on the top of the base unit 12, the connection conduit 106 is aligned with and is received in the suction conduit 38 of the base unit with a tight friction fit that seals that conduit connection.

During operation of this embodiment dirt and debris is swept by the bristle tufts 22 of the rotary agitator 18 into the air stream being draw into the suction inlet 20 by means of the suction generator 26. The air stream entrained with dirt and debris is then serially drawn through the conduit 64 and the suction tube 96 to the interior of the filter bag 76. The dirt and debris is trapped in the filter bag 76 while the clean air, capable of passing through the filter bag material is drawn through the exhaust vent 108 at the bottom of the bag compartment 74. From there the air stream is directed through the connection conduit 106 and suction conduit 38 to the suction generator compartment 24. The air stream then passes over the motor of the suction generator 26 to provide cooling before exiting the suction generator compartment 24 and passing into the cord reel compartment 28. There the air stream cools the cord reel assembly 30 before being exhausted from the vacuum cleaner through the final filter 67 and the exhaust vent 68.

As should be appreciated, the base unit 12 may be fitted with either the first dirt collection module 14 including a dirt cup 42 or the second dirt collection module 70 including a bag compartment 74 and filter bag 76. Thus, a base unit 12 of one individual design and construction may be used to manufacture an upright vacuum cleaner 10 of the dirt cup or filter bag type. Accordingly, it should be appreciated a method of reducing vacuum cleaner manufacturing costs is provided. That method includes the steps of (a) producing at least two base units 12 of a single embodiment including a suction inlet 20 and a suction generator 26, (b) producing a first dirt collection module 14 having a dirt cup 42, (c) producing a second dirt collection module 70 having a bag compartment 74 and filter bag 76, (d) attaching a first dirt collection module to one of the two base units to make an upright vacuum cleaner with a dirt cup and (e) attaching the second dirt collection module to another of the at least two base units to make an upright vacuum cleaner with a filter bag. Thus, a single embodiment of base unit is utilized to make two types of upright vacuum cleaners thereby reducing design, parts and manufacturing costs.

The method may further include the steps of (a) providing a locating element 36 on the base unit 12 for properly locating the first dirt collection module 14 and, more specifically, the dirt cup 42, thereon and (s) optionally providing an adapter 80 overlying the locating element for property supporting the second dirt collection module 70. This allows the second dirt collection module 70 to be connected to the base unit 12 instead of the first dirt collection module 14. Further, the method includes providing the locating element 36 with an undercut 90 and providing the adapter 80 with a projecting or retaining rib 88 received and held in the undercut.

The foregoing description of the preferred embodiments of the vacuum cleaner have been presented for purposes of illustration and description. It is not intended to be exhaustive or to limit the vacuum cleaner to the precise form disclosed. Obvious modifications or variations are possible in light of the above teachings. For example, while the suction generator 26 is carried in a suction generator compartment 24 of the base unit 12 in the illustrated embodiments, it should be appreciated that the suction generator could be provided in the modules 14, 70 if desired. The embodiments were chosen and described to enable one of ordinary skill in the art to utilize the vacuum cleaner in various embodiments and with various modifications as are suited to the particular use contemplated. The drawings and preferred embodiments do not and are not intended to limit the ordinary meaning of the claims in their fair and broad interpretation in any way.

What is claimed:

1. An upright vacuum cleaner, comprising:
a base unit including a suction inlet, a suction generator carried on said vacuum cleaner and a locating element;
a first dirt collection module having a receiver that cooperates and engages with said locating clement whereby said first dirt collection module may be properly secured to said base unit;
a second dirt collection module; and
an adapter whereby said second dirt collection module may be properly secured to said base unit instead of said first dirt collection module, said adapter being positioned between said locating element and said second dirt collection module.

2. The vacuum cleaner of claim I, wherein said base unit further includes a suction conduit and a dirt collection module mounting boss.

3. The vacuum cleaner of claim 2, wherein said first and second dirt collection modules both include (a) a connection conduit that engages said suction conduit and (b) a mounting element that engages said mounting boss.

4. The vacuum cleaner of claim 3, further including a fastener that is received in said mounting boss and said mounting element of either of said first and second dirt collection modules when either of said modules is properly seated on said base unit.

5. The vacuum cleaner of claim 4, wherein said suction conduit and said mounting boss are adjacent to one another.

6. The vacuum cleaner of claim 5, wherein said connection conduit has a first end that friction fits inside an open end of said suction conduit.

7. The vacuum cleaner of claim 6, wherein said mounting boss nests inside said mounting element of either of said first and second dirt collection modules.

8. The vacuum cleaner of claim 7, wherein said first dirt collection module includes a dirt cup.

9. The vacuum cleaner of claim 1, wherein said first dirt collection module includes a dirt cup.

10. The vacuum cleaner of claim 9, wherein said dirt cup includes a bottom wall and said receiver is provided on said bottom wall.

11. The vacuum cleaner of claim 10, wherein said receiver is a cavity.

12. The vacuum cleaner of claim 1, wherein said second dirt collection module includes a housing defining a bag compartment and a filter bag is held in said bag compartment.

13. The vacuum cleaner of claim 12, wherein said locating element is a projecting lug including an undercut.

14. The vacuum cleaner of claim 13, wherein said adapter includes a retaining rib received in said undercut to provide a secure connection.

15. The vacuum cleaner of claim 14, wherein said housing of said second dirt collection module includes an access door.

16. The vacuum cleaner of claim 15, wherein, said adapter includes a first projection and a second projection.

17. The vacuum cleaner of claim 16, wherein said first projection is received in a first cavity provided in said housing and said second projection is received in a second cavity provided in said access door.

18. A method of reducing vacuum cleaner manufacturing costs, comprising:
producing at least two base units of a single embodiment including a suction inlet;
producing a first dirt collection module having a dirt cup;
producing a second dirt collection module having a bag compartment and a filter bag;
attaching said first dirt collection module to one of said at least two base units to make an upright vacuum cleaner with a dirt cup; and
attaching said second dirt collection module to another of said at least two base units to make an upright vacuum cleaner with a filter bag;
whereby only a single embodiment of a base unit is utilized to make two different types of upright vacuum cleaners thereby reducing parts and manufacturing costs.

19. The method of claim 18, including providing a locating element on said base unit for properly locating said first dirt collection module thereon and optionally providing an adapter overlying said locating element for properly supporting said second dirt collection module when said second dirt collection module is to be connected to said base unit.

20. The method of claim 19, including;
providing said locating element with an undercut; and
providing said adaptor with a retaining rib received and held in said undercut.
